(19) United States
(12) Patent Application Publication
(10) Pub. No.: US 2011/0026214 A1
(43) Pub. Date: Feb. 3, 2011

(54) STORAGE DEVICE

(75) Inventors: Hajime MATSUMOTO, Tokyo (JP); Toshihiro Tsujimura, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, TOKYO (JP)

(21) Appl. No.: 12/842,525

(22) Filed: Jul. 23, 2010

(30) Foreign Application Priority Data
Jul. 31, 2009 (JP) 2009-179584

(51) Int. Cl. G06F 1/16

(52) U.S. Cl. 361/679.31

(57) ABSTRACT

According to one embodiment, a storage device includes a multilayer wiring board; an internal circuit formed to include a memory device mounted on the multilayer wiring board; a plurality of connector terminals formed on the multilayer wiring board and used for connection to an external apparatus; and a plurality of connector pads formed on the multilayer wiring board and configured to connect wires in the internal circuit and the connector terminals, a connector pad for signals among the connector pads including a micro-strip line including a signal conductor pattern conductor on a surface layer and an internal layer ground conductor. The micro-strip line is formed by patterning a plurality of internal layer ground conductors such that the internal layer ground conductor is set as a target of the signal conductor pattern conductor on the surface layer.

### CROSS-REFERENCE TO RELATED APPLICATIONS

This application is based upon and claims the benefit of priority from Japanese Patent Application No. 2009-179584, filed on Jul. 31, 2009; the entire contents of which are incorporated herein by reference.

### FIELD

Embodiments described herein relate generally to a storage device.

### BACKGROUND

In the serial advanced technology attachment (SATA) standard and a serial attached SCSI (SAS) standard, to secure accurate signal transmission of a SATA signal and a SAS signal as high-speed differential signals, impedance and the like that a transmission line should observe are specified.

In a storage device mounted with an internal circuit including memory devices on a multilayer wiring board, to enable exchange of storage data by the SATA signal and the SAS signal, connector pads that connect connector terminals, to which cable connectors are connected, and the internal circuit including the memory devices are provided.

However, in the past, fluctuation in impedance is large in this connector pad section. Therefore, it is difficult to adapt the storage device to the SATA standard and the SAS standard.

### BRIEF DESCRIPTION OF THE DRAWINGS

FIG. 1 is a plan view illustrating the external configuration of a main part of a storage device according to an embodiment;

FIGS. 2A and 2B are respectively a plan view and a perspective view illustrating a first pattern design example of a differential micro-strip line included in a connector pad shown in FIG. 1;

FIGS. 3A and 3B are respectively a plan view and a perspective view illustrating a second pattern design example of the differential micro-strip line included in the connector pad shown in FIG. 1;

FIGS. 4A and 4B are respectively a plan view and a perspective view illustrating a third pattern design example of the differential micro-strip line included in the connector pad shown in FIG. 1;

FIGS. 5A and 5B are respectively a plan view and a perspective view illustrating a fourth pattern design example of the differential micro-strip line included in the connector pad shown in FIG. 1;

FIG. 6 is a characteristic chart illustrating changes in differential impedance measured by TDR measurement in transmission lines including the differential micro-strip lines shown in FIGS. 2A and 2B to FIGS. 5A and 5B;

FIG. 7 is a characteristic chart illustrating changes in differential return losses in the transmission lines including the differential micro-strip lines shown in FIGS. 2A and 2B to FIGS. 5A and 5B; and

FIG. 8 is a diagram illustrating standard values of differential return losses in the SATA standard.

### DETAILED DESCRIPTION

In general, according to one embodiment, a storage device includes a multilayer wiring board; an internal circuit formed to include a memory device mounted on the multilayer wiring board; a plurality of connector terminals formed on the multilayer wiring board and used for connection to an external apparatus; and a plurality of connector pads formed on the multilayer wiring board and configured to connect wires in the internal circuit and the connector terminals, a connector pad for signals among the connector pads including a micro-strip line including a signal conductor pattern conductor on a surface layer and an internal layer ground conductor. The micro-strip line is formed by patterning a plurality of internal layer ground conductors such that the internal layer ground conductor is set as a target of the signal conductor pattern conductor on the surface layer.

Exemplary embodiments of the storage device will be explained in detail below with reference to the accompanying drawings. The present invention is not limited to the following embodiments.

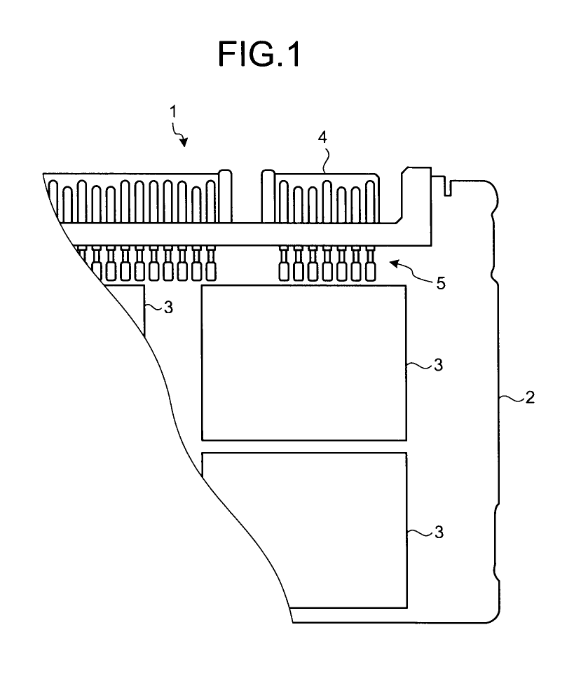

FIG. 1 is a plan view illustrating the external configuration of a main part of a storage device according to an embodiment. In FIG. 1, in a storage device (solid state drive: SSD) 1, a plurality of nonvolatile memory devices 3 are mounted on a multilayer wiring board 2. An internal circuit for the memory devices 3 and the like, a plurality of connector terminals 4, and a plurality of connector pads 5 are formed on the multilayer wiring board 2. As the memory devices 3, for example, a NAND flash memory is adopted.

Connectors of an external apparatus are connected to the connector terminals 4. The connector terminals 4 are connected to the connector pads 5 by a plurality of connection spring pieces not shown in the figure. The connector terminals 4 and the connection spring pieces are fixed by solder. The connector pads 5 and the connection spring pieces are fixed by solder. The connector pads 5 are connected to the memory devices 3 and the internal circuit on the board via surface layer wiring and internal layer wiring. A connector pad for signals among the connector pads 5 includes a differential micro-strip line.

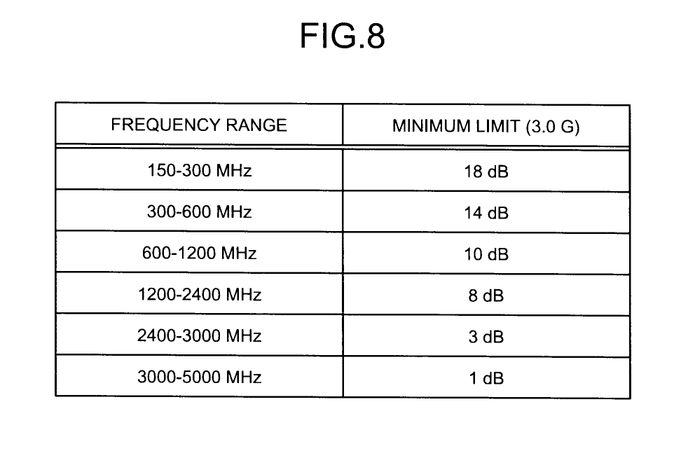

In the SATA standard and the SAS standard, to secure accurate signal transmission of a SATA signal and a SAS signal as high-speed differential signals, differential impedance of a transmission line is specified. In the SATA standard, because reflection increases when a section where impedance widely fluctuates is present in the transmission line, differential return losses are specified as standard values with respect to the impedance fluctuation (see FIG. 8).

The differential impedance of the entire transmission line is divided into impedance in a line (a cable, etc.) up to the connector terminals 4 and impedance in a path reaching from the connector terminals 4 to the connector pads 5, the memory devices 3, and the like. In the path reaching from the connector terminals 4 to the memory devices 3 and the like, fluctuation in the differential impedance is large in the section of the connector pad 5 including the differential micro-strip line. This causes a loss of a margin with respect to the standard values of the differential return losses and an excess over the standard values.

The impedance of the micro-strip line depends on the thickness of a dielectric layer interposed between a conductor line and a ground (GND) conductor. This is the same in the differential micro-strip line. Therefore, in the differential micro-strip line included in the connector pad 5 on the multilayer wiring board 2, the differential impedance is adjusted according to which GND layer from the top is set as a GND layer for a signal conductor pattern conductor on a surface layer.

However, the differential micro-strip line included in the connector pad 5 is formed in a curved shape such that a section soldered to the signal conductor pattern conductor on the surface layer has an appropriate inductance component. Therefore, it is difficult to select a target GND layer. The differential impedance tends to fluctuate in the section of the connector pad 5.

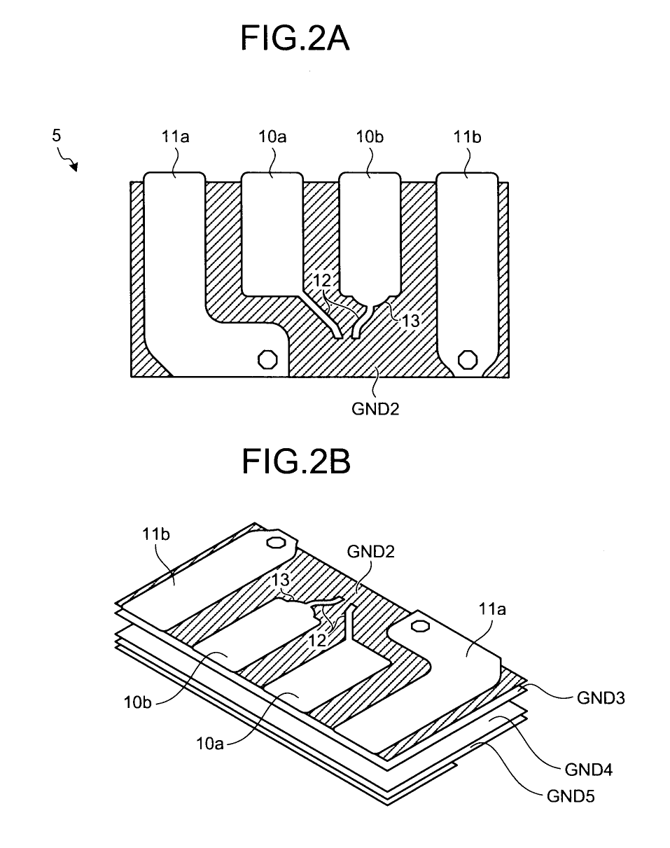

Therefore, in this embodiment, for example, as shown in FIGS. 2A and 2B to FIGS. 5A and 5B, the target GND layer in the differential micro-trip line included in the connector pad 5 is variously changed to select the target GND layer that reduces the fluctuation in the differential impedance. FIGS. 2A and 2B to FIGS. 5A and 5B are diagrams illustrating first to fourth pattern design examples of the differential micro-strip line included in the connector pad section shown in FIG. 1. FIGS. 2A, 3A, 4A, and 5A are plan views and FIGS. 2B, 3B, 4B, and 5B are perspective views. In the plan views, the upper side is the side of the connector terminals 4 and the lower side is the side of the memory devices 3 and the like. In the perspective views, although a dielectric layer is not shown, GND layers as internal layers are shown with the side of the connector terminals 4 set on the obliquely lower left and the side of the memory devices 3 and the like set on the obliquely upper right.

In FIGS. 2A and 2B to FIGS. 5A and 5B, to facilitate understanding, the target GND layer is selected for a pair of signal conductor pattern conductors 10a and 10b formed on the surface layer in the differential micro-strip line included in the connector pad 5. GND conductor pattern conductors 11a and 11b are also shown on both sides. However, the GND conductor pattern conductors 11a and 11b are not important in this explanation.

In the signal conductor pattern conductor 10a, a conductor line 12 directly to the internal circuit is drawn out from an end on the side of the memory devices 3 and the like. In the signal conductor pattern conductor 10b, a drawing-out section 13 is provided to project at an end on the side of the memory devices 3 and the like. The conductor line 12 is drawn out from the drawing-out section 13. In FIGS. 2A and 2B to FIGS. 5A and 5B, the signal conductor pattern conductors 10a and 10b are shown in a rectangular shape for convenience of explanation. However, as explained above, actually, the signal conductor pattern conductors 10a and 10b are formed in an arbitrary shape including a so-called land to which connection lines of the memory devices 3 and the internal circuit on the board are soldered.

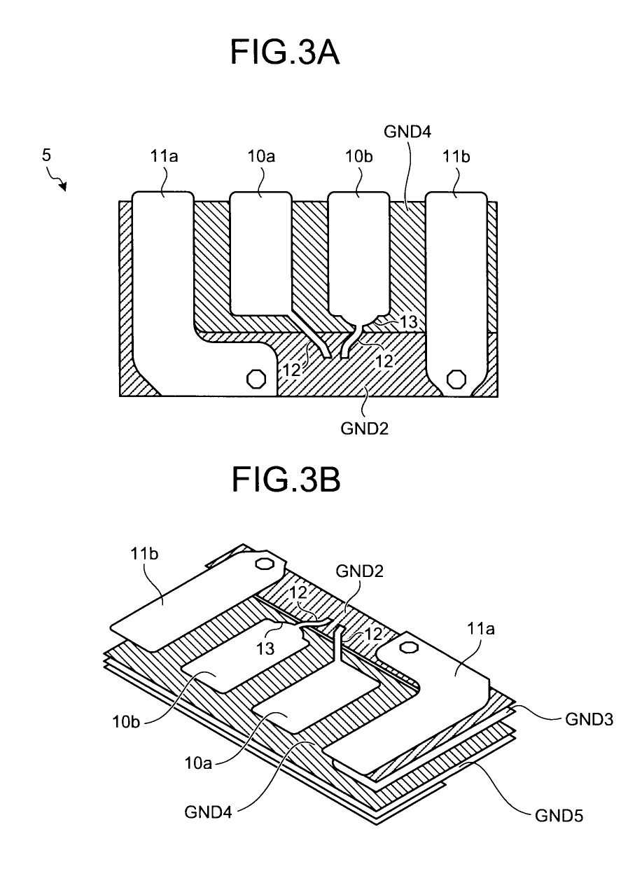

In the differential micro-strip line shown in FIGS. 2A and 2B, the target GND layer of the signal conductor pattern conductors 10a and 10b on the surface layer includes an entire GND layer GND2 as a second layer. In the differential micro-strip line shown in FIGS. 3A and 3B, a GND layer for the entire differential micro-strip line including the drawing-out section 13 from the side of the connector terminals 4 of the signal conductor pattern conductors 10a and 10b on the surface layer is a GND layer GND4 as a fourth layer. A GND layer for the differential micro-strip line on the side of the memory devices 3 and the like is the GND layer GND2 as the second layer.

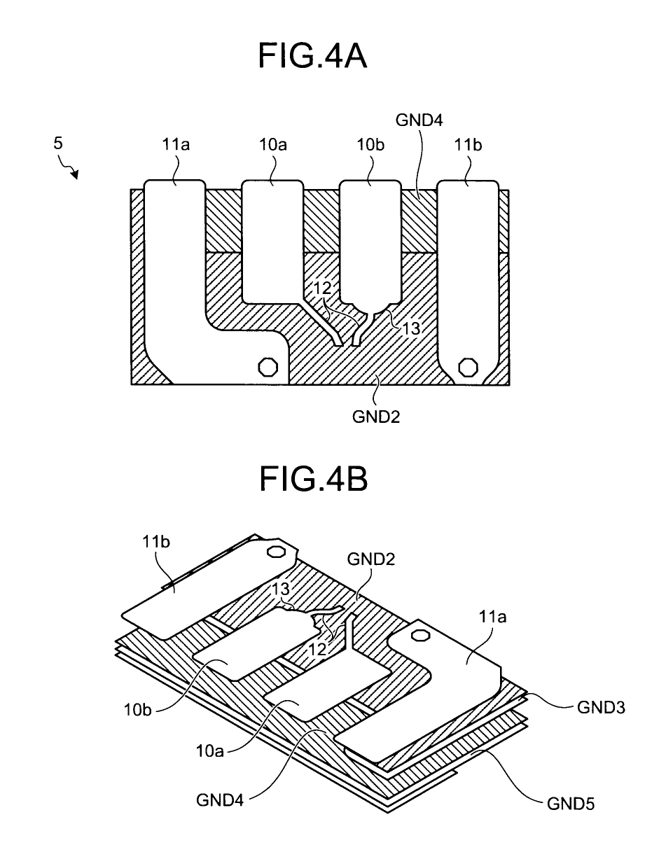

In the differential micro-strip line shown in FIGS. 4A and 4B, a longitudinal direction, which is a signal propagating direction of the signal conductor pattern conductors 10a and 10b, is divided substantially in the middle. A GND layer for the half on the side of the connector terminals 4 is the GND layer GND4 as the fourth layer. A GND layer for the differential micro-strip line on the board side in the half on the side of the memory devices 3 and the like is the GND layer GND2 as the second layer.

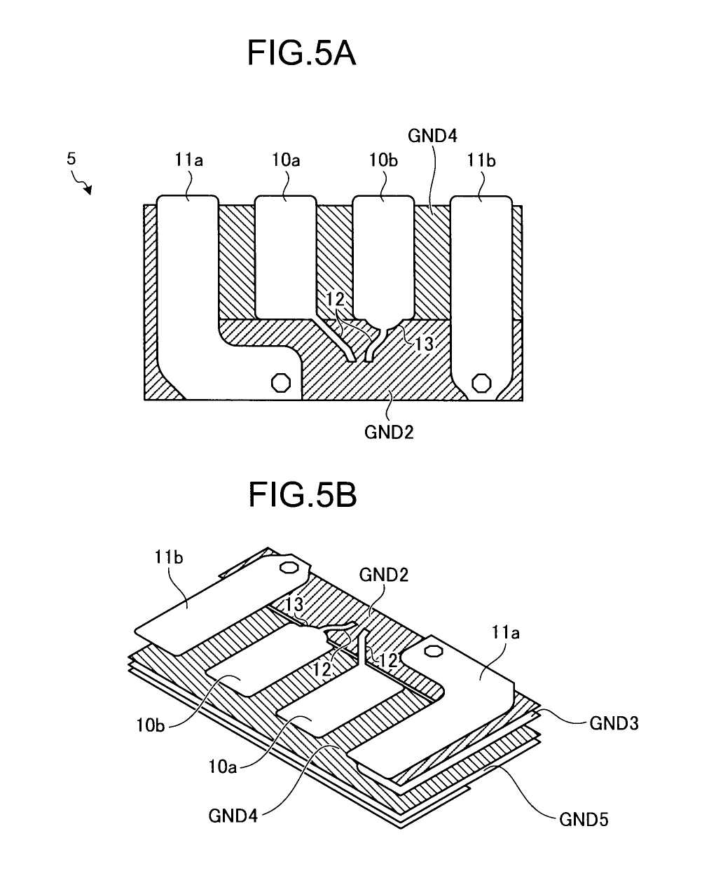

In the differential micro-strip line shown in FIGS. 5A and 5B, a GND layer for the entire signal conductor pattern conductors 10a and 10b not including the drawing-out section 13 is the GND layer GND4 as the fourth layer. A GND layer for the differential micro-strip line on the board side including the drawing-out section 13 is the GND layer GND2 as the second layer.

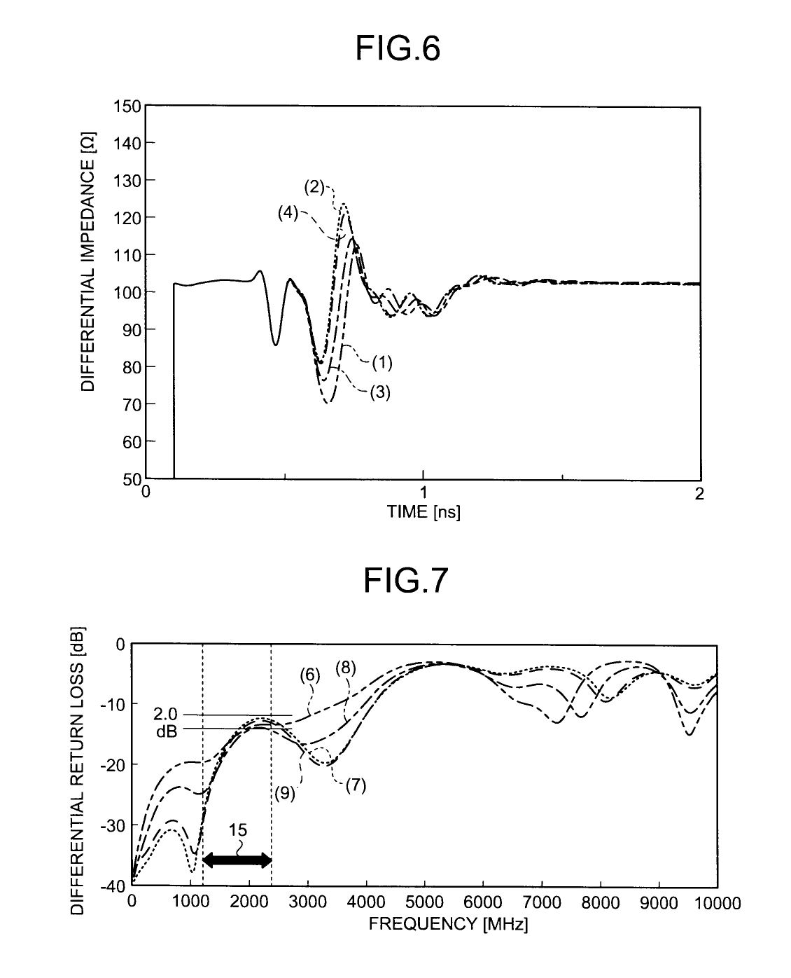

Evaluation results for the differential micro-strip lines shown in FIGS. 2A and 2B to FIGS. 5A and 5B formed as the connector pad 5 are explained with reference to FIGS. 6 to 8. FIG. 6 is a characteristic chart illustrating changes in differential impedance measured by TDR measurement in transmission lines including the differential micro-strip lines shown in FIGS. 2A and 2B to FIGS. 5A and 5B. FIG. 7 is a characteristic chart illustrating changes in differential return loses in the transmission lines including the differential micro-strip lines shown in FIGS. 2A and 2B to FIGS. 5A and 5B. FIG. 8 is a diagram illustrating standard values of differential return losses in the SATA standard.

In FIG. 6, the ordinate axis represents differential impedance [Ω]. Scales from 50 Ω to 150 Ω are marked on the ordinate axis. The abscissa axis represents time [ns] from application of a pulse to a transmission line until reflection and return of the pulse measured by the time domain reflectometory (TDR). The time is substantially proportional to a distance. The left on the abscissa axis is the side of the connector terminals 4 and the right on the abscissa axis is the board side. A characteristic (1) is a differential impedance characteristic in the transmission line including the differential micro-strip line shown in FIGS. 2A and 2B. A characteristic (2) is a differential impedance characteristic in the transmission line including the differential micro-strip line shown in FIGS. 3A and 3B. A characteristic (3) is a differential impedance characteristic in the transmission line including the differential micro-strip line shown in FIGS. 4A and 4B. A characteristic (4) is a differential impedance characteristic in the transmission line including the differential micro-strip line shown in FIGS. 5A and 5B.

The characteristics (1) to (4) widely fluctuate in the same manner in the same place. This fluctuation place corresponds to the section of the connector pad 5. On the left side (the side of the connector terminals 4) and the right side (the board side) of the fluctuation place, the differential impedance shows a stable characteristic at about 100 ohms. In the fluctuation place, on the side of the connector terminals 4, the differential impedance falls from 100 ohms and then rises to 100 ohms. On the board side, the differential impedance rises to exceed 100 ohms and then falls to 100 ohms.

As shown in FIG. 6, changing width in the characteristics (3) and (4) is smaller than changing width in the characteristics (1) and (2). In the characteristics (1) and (2), the differential impedance rises and falls at substantially the same changing width. On the other hand, in the characteristics (3) and (4), an amount of fall of the differential impedance from 100 ohms decreases on the side of the connector terminals 4 and an amount of rise of the differential impedance from 100 ohms decreases on the board side. The changing width in the characteristic (3) is slightly smaller than the changing width in the characteristic (4).

This difference is examined below. In the structure of the differential micro-strip lines shown in FIGS. 2A and 2B and FIGS. 3A and 3B, as the target GND layer, the same GND layer is selected for the entirety of the signal conductor pattern conductors 10a and 10b and the conductor lines 12 drawn out therefrom. Therefore, the differential impedance as a whole in the section of the connector pad 5 is designed to be raised and lowered. In the line structure shown in FIGS. 2A and 2B and FIGS. 3A and 3B, it can be said that a fluctuation amount of the differential impedance cannot be suppressed.

On the other hand, in the structure of the differential micro-strip lines shown in FIGS. 4A and 4B and FIGS. 5A and 5B, the signal conductor pattern conductors 10a and 10b not including the drawing-out section 13 are divided into two on the side of the connector terminals 4 and the side of the memory devices 3 in the signal propagating direction. In the half on the side of the connector terminals 4, a GND layer farther from the surface layer is set as a target. On the board side including the half on the side of the memory devices 3, a GND layer closer to the surface layer is set as a target (FIGS. 4A and 4B). Alternatively, on the side of the connector terminals 4 corresponding to the entire signal conductor pattern conductors 10a and 10b not including the drawing-out section 13, a GND layer farther from the surface layer is set as a target. On the board side on the side of the memory devices 3 including the drawing-out section 13, a GND layer closer to the surface layer is set as a target (FIGS. 5A and 5B). In this way, the target GND layer is set different on the side of the connector terminals 4 and the board side. Therefore, it can be said that a fluctuation amount of the differential impedance in the section of the connector pad 5 can be suppressed. When the characteristics (3) and (4) are compared, the configuration shown in FIGS. 4A and 4B is excellent.

Next, differential return losses are explained. As shown in FIG. 8, minimum values of differential return losses are set for respective frequency ranges of “150 MHz to 300 MHz”, “300 MHz to 600 MHz”, “600 MHz to 1200 MHz”, “1200 MHz to 2400 MHz”, “2400 MHz to 3000 MHz”, and “3000 MHz to 5000 MHz”.

In FIG. 7, the ordinate axis represents a differential return loss [dB]. Scales from 0 dB to −40 dB are marked on the ordinate axis. The abscissa axis represents a frequency [MHz]. Scales from 0 MHz to 10000 MHz are marked on the abscissa axis. A frequency range 15 is “1200 MHz to 2400 MHz”. A differential return loss characteristic in the frequency range 15 is a characteristic that occurs in the section of the connector pad 5.

In FIG. 7, a characteristic (6) is a differential return loss characteristic in the transmission line including the differential micro-strip line shown in FIGS. 2A and 2B. A characteristic (7) is a differential return loss characteristic in the transmission line including the differential micro-strip line shown in FIGS. 3A and 3B. A characteristic (8) is a differential return loss characteristic in the transmission line including the differential micro-strip line shown in FIGS. 4A and 4B. A characteristic (9) is a differential return loss characteristic in the transmission line including the differential micro-strip line shown in FIGS. 5A and 5B.

In the frequency range 15 of “1200 MHz to 2400 MHz”, the characteristic (7) in the structure of the differential micro-strip line shown in FIGS. 3A and 3B is a strictest characteristic with little margin with respect to a minimum value “8 dB”. On the other hand, it is seen that the characteristic (8) in the structure of the differential micro-strip line shown in FIGS. 4A and 4B is improved by about 2.0 dB compared with the characteristic (7). The characteristic (9) in the structure of the differential micro-strip line shown in FIGS. 5A and 5B is also improved by a smaller degree.

As explained above, in the differential micro-strip line formed in the connector pad section, the signal conductor pattern conductor including a so-called land formed on the surface layer is divided into two on the side of the connector terminals 4 and the side of the memory devices 3 in the signal propagating direction. As the target GND layer, the GND layer farther from the surface layer is selected in the half on the side of the connector terminals 4 and the GND layer closer to the surface layer is selected on the board side in the half on the memory devices 3 (FIGS. 4A and 4B). This makes it possible to suppress a fluctuation amount in the differential impedance in the connector pad section. As a result, it is possible to increase a margin with respect to the standard values of the differential return losses.

Therefore, according to the embodiment, it is possible to realize a storage device that can be adapted to the SATA standard and the SAS standard. In the explanation of this embodiment, fluctuation in the differential impedance of the differential micro-strip line is suppressed. However, the embodiment can also be applied when impedance fluctuation of a so-called single micro-strip line is suppressed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device, comprising:
a multilayer wiring board;
an internal circuit formed to include a memory device mounted on the multilayer wiring board;
a plurality of connector terminals formed on the multilayer wiring board and used for connection to an external apparatus; and
a plurality of connector pads formed on the multilayer wiring board and configured to connect wires in the internal circuit and the connector terminals, a connector pad for signals among the connector pads including a micro-strip line including a signal conductor pattern conductor on a surface layer and an internal layer ground conductor, wherein
the micro-strip line is formed by patterning a plurality of internal layer ground conductors such that the internal layer ground conductor is set as a target of the signal conductor pattern conductor on the surface layer.

2. The storage device according to claim 1, wherein the micro-strip line is a differential micro-strip line.

3. The storage device according to claim 1, wherein the memory device is a NAND nonvolatile memory device.

4. A storage device, comprising:
a multilayer wiring board;
an internal circuit formed to include a memory device mounted on the multilayer wiring board;
a plurality of connector terminals formed on the multilayer wiring board and used for connection to an external apparatus; and
a plurality of connector pads formed on the multilayer wiring board and configured to connect wires in the internal circuit and the connector terminals, a connector pad for signals among the connector pads including a micro-strip line including a signal conductor pattern conductor on a surface layer and an internal layer ground conductor, wherein
the micro-strip line is formed by patterning a plurality of internal layer ground conductors such that, in a section closer to the connector terminals, an internal layer ground conductor in a layer farther from the surface layer is set as a target internal layer ground conductor of the signal conductor pattern conductor on the surface layer.

5. The storage device according to claim 4, wherein the micro-strip line is a differential micro-strip line.

6. The storage device according to claim 4, wherein the memory device is a NAND nonvolatile memory device.

7. A storage device, comprising:
a multilayer wiring board;
an internal circuit formed to include a memory device mounted on the multilayer wiring board;
a plurality of connector terminals formed on the multilayer wiring board and used for connection to an external apparatus; and
a plurality of connector pads formed on the multilayer wiring board and configured to connect wires in the internal circuit and the connector terminals, a connector pad for signals among the connector pads including a micro-strip line including a signal conductor pattern conductor on a surface layer and an internal layer ground conductor, wherein
when the micro-strip line is formed by patterning a plurality of internal layer ground conductors such that, in a section closer to the connector terminals, an internal layer ground conductor in a layer farther from the surface layer is set as a target internal layer ground conductor of the signal conductor pattern conductor on the surface layer,
the micro-strip line is formed by patterning internal layer ground conductors in two layers such that the target internal layer ground conductor of the signal conductor pattern conductor on the surface layer is formed by internal layer ground conductors in different two layers, and switching of the internal layer ground conductors in the different two layers is performed substantially in a center in a signal propagating direction of the signal conductor pattern conductor on the surface layer.

8. The storage device according to claim 7, wherein the micro-strip line is a differential micro-strip line.

9. The storage device according to claim 7, wherein the memory device is a NAND nonvolatile memory device.

10. A storage device, comprising:
a multilayer wiring board;
an internal circuit formed to include a memory device mounted on the multilayer wiring board;
a plurality of connector terminals formed on the multilayer wiring board and used for connection to an external apparatus; and
a plurality of connector pads formed on the multilayer wiring board and configured to connect wires in the internal circuit and the connector terminals, a connector pad for signals among the connector pads including a micro-strip line including a signal conductor pattern conductor on a surface layer and an internal layer ground conductor, wherein
the micro-strip line is formed by two internal layer ground conductors such that the internal layer ground conductor is set as a target of the signal conductor pattern conductor on the surface layer.

11. The storage device according to claim 11, wherein
in the two internal layer ground conductors, the internal layer ground conductor farther from the surface layer is on a side of the connector terminals and the internal layer ground conductor closer to the surface layer is on a side of the internal circuit, and
the two internal layer ground conductors are formed to be switched substantially in a center in a signal propagating direction of the signal conductor pattern conductor on the surface layer.

12. The storage device according to claim 11, wherein the micro-strip line is a differential micro-strip line.

13. The storage device according to claim 11, wherein the memory device is a NAND nonvolatile memory device.
